(19) United States
(12) Patent Application Publication
(10) Pub. No.: US 2005/0181834 A1
(43) Pub. Date: Aug. 18, 2005

(54) Method and apparatus for cell-site ARQ generation under softer handoff conditions

(75) Inventors: Wanshi Chen, San Diego, CA (US); Rath Vannithamby, San Diego, CA (US); Shiau-He Shawn Tsai, San Diego, CA (US); Young Yoon, San Diego, CA (US); Anthony C.K. Soong, Superior, CO (US); Tao Wu, Carlsbad, CA (US)

Correspondence Address: COATS & BENNETT, PLLC, P O BOX 5, RALEIGH, NC, 27602, US

(73) Assignee: Telefonaktiebolaget L M Ericsson (publ)

(21) Appl. No.: 11/017,338

(22) Filed: Dec. 20, 2004

Related U.S. Application Data
(60) Provisional application No. 60/544,037, filed on Feb. 12, 2004.

(51) Int. Cl. H04Q 7/20

(52) U.S. Cl. 455/562.1

(57) ABSTRACT

A base station generates per-cell ACK/NACK responses rather than per-sector ACK/NACK responses. For a given mobile station signal received in softer handoff at two of the base station's sectors, the base station generates an ACK response if at least one of the soft handoff sectors correctly receives the signal, and otherwise generates a NACK response. Alternatively, the base station can combine the softer handoff signals and generate ACK/NACK responses based on whether the combined signal is correctly received. Since only one set of ACK/NACK responses are generated for all of the softer handoff sectors, the base station can use the forward link in just one softer handoff sector to send the ACK/NACK responses to the mobile station, consuming fewer forward link transmit resources at the base station. Or, the base station can send the same ACK/NACK responses from two or more softer handoff sectors, thus allowing diversity combining of the ACK/NACK responses at the mobile station.

### RELATED APPLICATIONS

The instant application claims priority under 35 U.S.C. § 119(e) from the U.S. provisional patent application filed on 12 Feb. 2004, entitled “ARQ Bit Transmission for Reverse H-ARQ Operation During Softer Handoff,” and assigned Application Ser. No. 60/544,037. That provisional application is expressly incorporated herein by reference.

### BACKGROUND OF THE INVENTION

The present invention generally relates to wireless communication networks, and particularly relates to Automatic Repeat Request (ARQ) generation under softer handoff conditions at a wireless communication network cell site.

Evolving network standards make increasing use of ARQ-based transmission schemes, wherein Acknowledge/Not-Acknowledge (ACK/NACK) responses sent from a first radio transceiver to indicate whether the signal from a second radio transceiver was correctly received. ARQ transmissions generally are performed on a frame-by-frame basis for “framed” data communication signals. For example, the developing IS-2000 standards specify the use of Hybrid ARQ (H-ARQ) signaling for reverse link packet data channel signals transmitted by the mobile stations.

In soft handoff conditions, the mobile station's reverse link signals are received at two or more radio base station sectors of the supporting wireless communication network, meaning that the mobile station has reverse radio links with at least two network receivers. With H-ARQ, ACK/NACK responses are independently generated and transmitted to the mobile station for each such link. For example, with four radio base station sectors in the mobile station's active set, the network receives and decodes the mobile station's reverse link packet data channel on each of four radio links, and generates ACK/NACK responses independently for each of those links. Thus, the mobile station can receive potentially conflicting ACK/NACK responses for each packet data frame transmitted by it.

Generally, the mobile station does not retransmit a given data frame unless none of the soft handoff sectors sends an ACK response. Thus, in the above example, the mobile station would retransmit only if none of its four soft handoff sectors successfully received its transmitted data frame. This logic allows the mobile station to reconcile the potentially different ACK/NACK responses received by the mobile station for its various soft handoff radio links. However, it forces the mobile station to receive and process the incoming ACK/NACK responses from each of its soft handoff sectors independently, which means that each sector must transmit those ACK/NACK responses at power levels sufficient for the prevailing radio conditions.

With softer handoff scenarios, two or more of the radio sectors in the mobile station's active set are at the same cell site—i.e., two or more of the radio sector receivers allocated for receiving the mobile station's reverse link data transmissions are at the same radio base station. In such contexts, the cell site as a whole may be considered as having successfully received a reverse link transmission from the mobile station if at least one of the softer handoff sectors at that cell site correctly received the transmission. However, a conventional approach to ACK/NACK response generation would call for generating independent and potentially conflicting ACK/NACK responses for each softer handoff link without regard to whether the cell site as whole did or did not receive the mobile station's transmission.

### SUMMARY OF THE INVENTION

The present invention comprises a method and apparatus to generate one set of ACK/NACK commands for a mobile station signal that is received in softer handoff at two or more radio base station sectors-at the same cell site. For example, an ACK response is generated if the mobile station signal is being received in softer handoff at three sectors of the cell site and any one of those sectors correctly receives the signal. Alternatively, the softer handoff signals from each softer handoff sector can be combined to form a combined signal, and the ACK/NACK responses can be commonly generated based on whether that combined signal is correctly received.

In either case, the ACK/NACK response is generated on a cell-site basis rather than on a per-sector basis, and the common ACK/NACK responses for that cell site can be transmitted back to the mobile station from each of the softer handoff sectors for diversity combining by the mobile, or, for more efficient use of forward link resources and/or to reduce forward link interference, the ACK/NACK responses can be transmitted from a selected one of the cell site's softer handoff sectors.

Thus, in one embodiment, the present invention comprises a method of generating ACK/NACKs responses at a cell site having multiple radio sectors based on receiving a mobile station signal at the cell site, generating ACK/NACK responses for the mobile station signal that are common to all of the sectors receiving the mobile station signal, and transmitting the ACK/NACK responses from the cell site to the mobile station. ACK responses are generated if at least one of the sectors correctly receives the mobile station signal and otherwise a NACK response is generated.

The responses can be sent to the mobile station from each of the cell site's sectors that are receiving the mobile station signal in softer handoff. Transmitting from multiple sectors has the advantage of allowing the mobile station to diversity combine the ACK/NACK responses received from multiple sectors of the same cell site for improved ACK/NACK command recognition. Diversity combining also allows reduced power levels for ACK/NACK signaling because of the combining-gain at the mobile station. However, some embodiments of the present invention forego the advantages of diversity combining at the mobile station in favor reducing forward link resource usage and/or interference by transmitting the ACK/NACK responses from one or fewer than all of the softer handoff sectors.

Another embodiment the present invention comprises a cell-site radio base station having multiple radio sectors and comprising sectorized radio transceiver circuits configured to transmit and receive signals in each of two or more sectors of the radio base station, and one or more processing circuits configured to generate ACK/NACK responses that are common to all of the sectors of the radio base station that receive a given mobile station signal in softer handoff. The processing circuit(s) may be configured as hardware, software, or any combination thereof. In at least one embodiment, the common ACK/NACK generation of the present invention is embodied in computer instructions for execution by one or more microprocessor circuits included in the radio base station.

In another embodiment, the present invention comprises a mobile station configured for a method of ACK/NACK processing based on receiving a common ACK/NACK response transmitted from each of two or more sectors of a radio base station, combining the received ACK/NACK responses, and controlling its retransmissions to the radio base station based on the combined ACK/NACK responses. In this method, the mobile station “diversity” combines the same ACK/NACK responses being transmitted from multiple sectors of the radio base station, thereby improving the reliability of ACK/NACK processing at the mobile station.

Of course, the present invention is not limited to the above features and advantages described for common ACK/NACK response generation at cell site radio base stations and for processing of those responses at the mobile station based on diversity combining. Those skilled in the art will recognize additional features and advantages upon reading the following detailed description, and upon viewing the accompanying figures.

### BRIEF DESCRIPTION OF THE DRAWINGS

One or more embodiments of the present invention are illustrated in the accompanying drawings, wherein:

FIG. 1 is a diagram of a wireless communication network according to one or more embodiments of the present invention;

FIG. 2 is a diagram of a cell-site radio base station including circuits configured for ACK/NACK processing in accordance with one or more embodiments of the present invention;

FIG. 3 is a diagram of ACK/NACK processing at a cell-site radio base station;

FIG. 4 is a diagram of ACK/NACK processing details corresponding to one embodiment of the ACK/NACK processing of FIG. 3;

FIG. 5 is a diagram of ACK/NACK processing details corresponding to another embodiment of the ACK/NACK processing illustrated in FIG. 3;

FIG. 6 is a diagram of a mobile station according to one or more embodiments of the present invention; and

FIG. 7 is a diagram of cell-site ACK/NACK transmission according to one or more embodiments of the present invention.

### DETAILED DESCRIPTION OF THE INVENTION

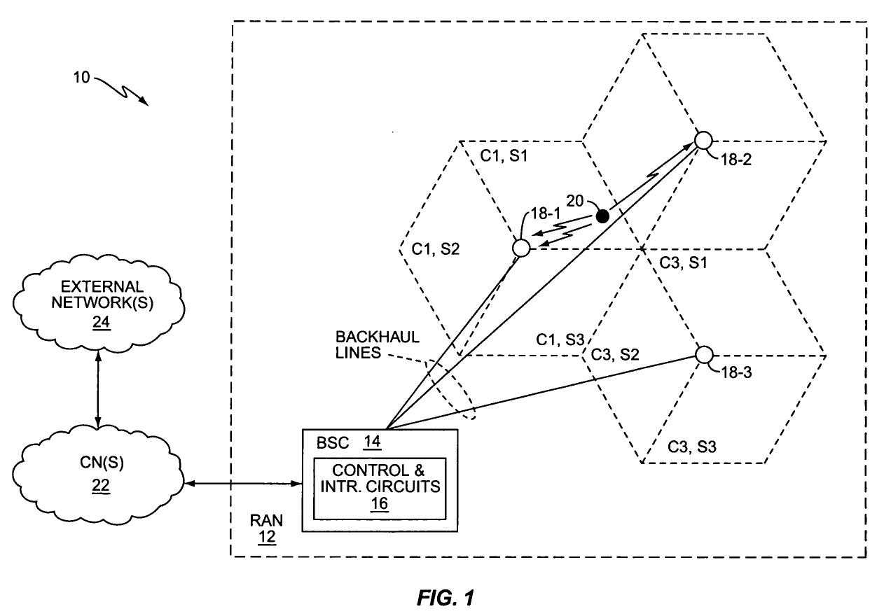

FIG. 1 illustrates a wireless communication network 10 that is configured to one or more embodiments of the present invention. Network 10 may comprise an IS-2000 based wireless communication network, a Wideband CDMA (W-CDMA) or some other type of wireless communication network that uses ARQ signaling to control retransmission of packet data from the mobile states being supported the network. Thus, the actual architecture of network 10 may vary somewhat depending on the standard adopted for its implementation, but for purposes of discussion the illustrated network 10 comprises a radio access network (RAN) 12 that includes at least one Base Station Controller (BSC) 14 having control and interface circuits 16, and supporting a plurality of cell-site Radio Base Stations (RBSs) 18-1 through 18-3. RAN 12 communicatively couples mobile stations 20 to one or more Core Networks (CNs) 22, which, in turn, are communicatively coupled to one or more external networks 24. In at least one embodiment, the CNs 22 include a Packet Switched Core Network (PSCN) that communicatively couples mobile stations 20 to one or more Public Data Networks (PDNs), such as the Internet.

From the illustration, one sees that each RBS 18 comprises a sectorized cell-site providing a plurality of independent radio sectors. For example, the RBS 18-1 cell-site includes sectors S1, S2, and S3. RBSs 18-2 and 18-3 likewise each provide multi radio sectors corresponding to different but possibly overlapping geographic regions of radio coverage.

Transmissions from the network 10 to a given mobile station 20 are broadly termed forward link transmissions, while transmissions from the mobile station 20 to the network 10 are broadly termed reverse link transmissions. In many types of networks, such as those based on IS-2000 standards, the reverse link transmissions from a given mobile station 20 are received and decoded by more than one cell-site sector. For example, one sees that the reverse link transmissions from the illustrated mobile station 20 are being received by sectors S1 and S3 of radio based station 18-1 and by sector S2 of radio based station 18-2. The condition wherein a given mobile station 20 has reverse radio links established with more than one sector is referred to as a “soft” handoff condition. With respect to the data being transmitted by the mobile station 20, BSC 14 successfully receives such data if one or both radio base stations 18-1 and 18-2 successfully receive such transmissions. Soft handoff therefore improves reception reliability on the reverse link.

“Softer” handoff is a special soft handoff condition, wherein the mobile station 20 has reverse radio links with more than one sector at the same cell-site. Thus, the illustrated mobile station 20 is in softer handoff with RBS 18-1 because mobile station 20 has reverse radio links established at sectors S1 and S3 of RBS 18-1. The particular sectors with which mobile station 20 has established reverse radio links varies from time to time and is generally defined by the network sectors that are members of the mobile station's “active set.” The radio sectors included in the active set generally is controlled by network 10 based on signal quality reports returned from the mobile station 20, indicating which ones of the network sectors are currently providing the mobile station with an acceptable received signal quality.

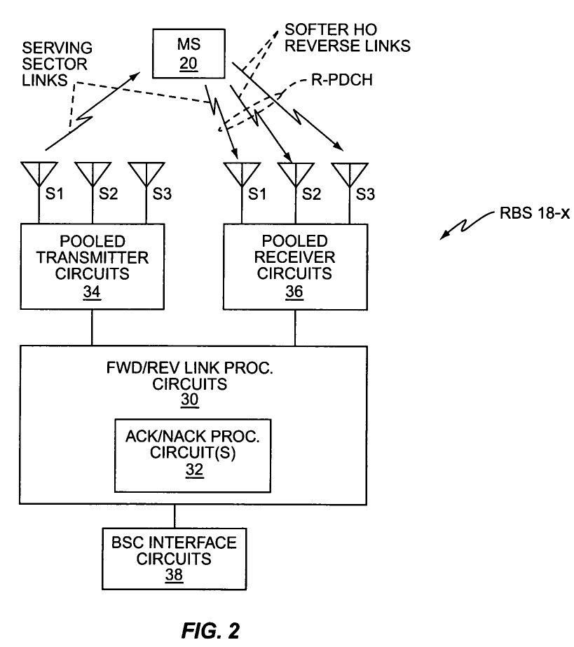

FIG. 2 more clearly illustrates the softer handoff condition and simultaneously provides supporting circuit details for at least one embodiment of a RBS 18 according to the present invention. To emphasize the softer handoff condition, FIG. 2 depicts mobile station 20 as being in softer handoff on the reverse link with all three sectors of the illustrated RBS 18. From the diagram, one sees that RBS 18 includes forward/reverse link processing circuits 30, including ACK/NACK processing circuits 32, pooled transmitter circuits 34, pooled receiver circuits 36, and BSC interface circuits 38.

According to the illustrated scenario, sector S1 is functioning as the mobile station's forward link serving sector, and sectors S1, S2, and S3, are all in a softer handoff condition with respect to the mobile station's reverse link. In an IS-2000 embodiment, the mobile station 20 may send a Reverse Packet Data Channel (R-PDCH) signal on the reverse link, such that the R-PDCH signal is received in softer handoff at each one of the RBS's sectors.

The R-PDCH channel is a framed data signal, meaning that the mobile station 20 transmits packet data on that channel as a series of timed data frames, and RBS 18 provides frame-by-frame ARQ feedback for those framed data transmissions in the form of ACK/NACK responses transmitted to the mobile station on the RBS's forward link. In accordance with the present invention, the ACK/NACK processing circuits 32 are configured such that the ACK/NACK responses are generated on a cell-site basis rather than a per-sector basis.

FIG. 3 broadly illustrates ACK/NACK response generation at RBS 18 in accordance with one or more embodiments of the present invention. The cell-site defined by RBS 18 receives mobile station transmissions in softer handoff (Step 100). RBS 18 generates ACK/NACK responses based on receiving the mobile station signal, wherein the generated ACK/NACK responses are commonly generated for all softer handoff sectors of RBS 18 (Step 102). Processing continues with the transmission of the commonly generated ACK/NACK responses from the cell-site to the mobile station (Step 104).

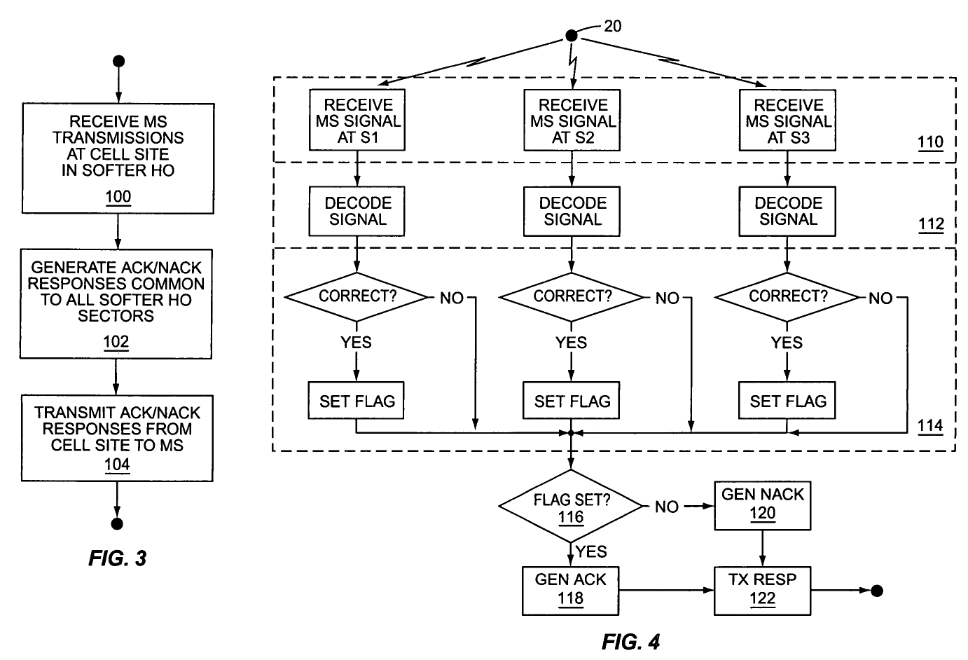

FIG. 4 illustrates details for one embodiment of the ACK/NACK processing illustrated in FIG. 3, wherein the common ACK/NACK responses are generated based on determining whether any sector of RBS 18 correctly received the mobile station signal. In that context, processing begins with each softer handoff sector receiving the mobile station signal (Step 110). Processing continues with decoding each softer handoff signal (Step 112) and the corresponding per-sector determination of whether the softer handoff signal received at each sector was correctly decoded (Step 114). The processing logic implemented in RBS 18 can be configured to set a flag or some other logical indicator on a per-sector basis to indicate whether the corresponding sector did or did not correctly decode the mobile station signal as received in softer handoff at that sector. Whether the mobile station's signal was “correctly” received can be based on performing a Cyclic Redundancy Check (CRC) of decoded data frames, for example.

With the above per-sector processing, the ACK/NACK processing circuits 32 can be configured to check whether any of the softer handoff sectors correctly decoded the mobile station signal (Step 16) and, if so, generate an ACK response (Step 118), or to otherwise generate a NACK response (Step 120). In any case, just one set of ACK/NACK responses are generated at the cell-site for the mobile station signal, and transmitted from the cell-site to the mobile station 20 (Step 122).

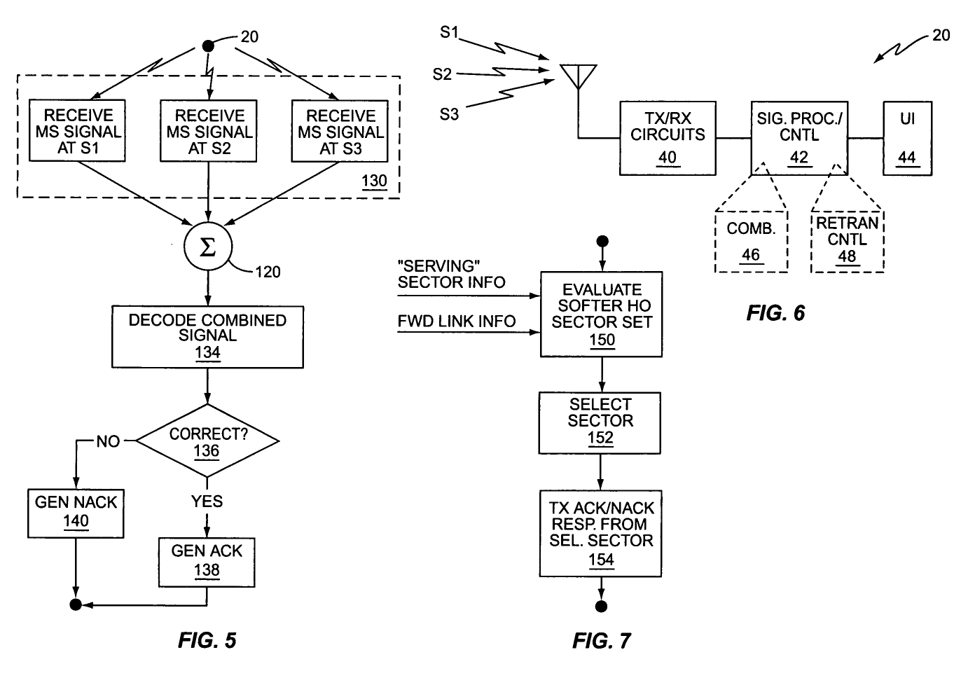

As an alternative to the processing logic of FIG. 4, the broad processing logic of FIG. 3 may be implemented according to the more detailed illustration of FIG. 5, wherein ACK/NACK processing is based on a combined signal formed from the softer handoff signals received at the cell-site sectors in softer handoff on the reverse link with the mobile station 20. This combined-signal approach is in contrast to the per-sector decoding and checking done according to the logic of FIG. 4, but the net result is the same in that the cell-site generates just one set of ACK/NACK responses for the mobile station signal rather than generating independent ACK/NACK responses for each of the softer handoff sectors.

Processing begins with the RBS 18 receiving the mobile station's reverse link signal in softer handoff at sectors S1, S2, and S3 (Step 130). Those signals are combined (Step 132), possibly using a maximum-ratio combining algorithm that can be implemented in the analog and/or digital domains. The resultant combined signal, which should have an improved signal quality as compared to the individual per-sector softer handoff signals, is decoded (Step 134). If the combined signal decodes correctly (Step 136), an ACK response is generated (Step 138). Otherwise, a NACK response is generated (Step 140). ACK/NACK response generation generally is performed on an ongoing basis as successive data frames are received from the mobile station 20.

It should be noted that in the context of FIG. 5 and, indeed in the context of all processing logic flows illustrated herein, the generation of ACK/NACK responses may be based on the explicit generation of different ACK/NACK signaling values, or may be based on the use of implicit and explicit signaling. As an example, Binary Phase Shift Keying (BPSK) can be used to signal explicit ACK and NACK signaling values, or ON/OFF Keying (OOK), can be used to signal an explicit ACK or NACK signal state via the on condition, with the off condition implicitly signaling the other state. Thus, it should be understood by those skilled in the art that the present invention is not limited to a particular ACK/NACK signaling scheme.

Regardless of the particular signaling method adopted for ACK/NACK response indication, the present invention contemplates a number of methods for transmitting the ACK/NACK responses to the mobile station 20. For example, the RBS 18 can be configured to transmit the same ACK/NACK response from each of its softer handoff sectors, such that the mobile station 20 receives the same ACK or NACK response on the forward radio link of each softer handoff sector. The advantage of transmitting the same ACK/NACK response from multiple sectors at the cell-site is that the mobile station can be configured to diversity-combine the duplicate ACK/NACK responses and thereby gain an improvement in reception reliability. The combining-gain associated with diversity reception at the mobile station 20 also may permit the RBS 18 to transmit the common ACK/NACK signaling from each softer handoff sector at a lower transmit power than would be required for independent reception by the mobile station of each sector's separate, conventional ACK/NACK signaling.

FIG. 6 illustrates a mobile station 20 that is configured to take advantage of the redundant ACK/NACK response transmissions from multiple softer handoff sectors of the RBS 18. The illustrated mobile station 20 comprises transceiver circuits 40, signal processing and control circuits 42, and a user interface 44, which may comprise a display, keypad, and audio input/output circuits.

The signal processing/control circuits 42 may be configured to include combining circuits 46 and retransmission control circuits 48, wherein the combining circuits 46 combine the ACK/NACK responses received on multiple forward radio links from a given softer handoff cell site (RBS) to obtain a combined ACK/NACK response signal having an improved signal quality. Complementing that operation, the retransmission control circuits 48 are configured to control reverse link retransmissions based on the diversity-combined ACK/NACK responses provided by the combining circuits 46.

Despite the diversity-combining advantages gained at the mobile station 20, it may be more desirable to limit ACK/NACK response transmissions to one or fewer than all softer handoff sectors at the cell site. Indeed, from the radio base station's perspective, it may be advantageous to restrict ACK/NACK response generation to the forward link in just one of the softer handoff sectors. The advantages gained in doing so include the consumption of fewer forward link transmission resources at the RBS 18 and potentially reduced forward link interference. The reduction in forward link resource usage comes from not having to transmit ACK/NACK responses on the forward link in each softer handoff sector. Likewise, reducing the number of forward radio links on which ACK/NACK responses are transmitted yields a potentially reduced amount of system interference.

With the above advantages in mind then, FIG. 7 illustrates processing logic that can be implemented at the RBS 18 to control the selection of which softer handoff sector is used for transmitting the ACK/NACK responses to the mobile station 20. Processing begins with the evaluation of the softer handoff sector set (Step 140). That evaluation can be as simple as identifying the softer handoff sector currently designated as the mobile station's forward link serving sector. It makes sense to use the serving sector's forward link to transmit the ACK/NACK responses because the forward link serving sector generally is the one offering the best radio transmission conditions relative to the mobile station 20.

However, the RBS 18 can be configured to carry out other types of selection evaluations. For example, the RBS 18 can be configured to evaluate various items of forward link information, such as the level of forward link resource loading at each of the softer handoff sectors. The point of this analysis is to identify the softer handoff sector having the least heavily loaded forward link, or the softer handoff sector having the greatest reserve of forward link transmit power available, or the softer handoff sector having the forward link that is otherwise best suited under the current conditions to transmit the ACK/NACK responses to the mobile station 20. Additionally, the sector can be selected as the one having the best history of being successful in sending the ACK/NAK, the sector having the best forward link, the sector that correctly decoded the mobile station's signal/packet, etc.

Thus, on whatever basis the RBS 18 uses, one of the softer handoff sectors is selected (Step 142) and the forward link in that selected sector is used to transmit the ACK/NACK responses to the mobile station 20 (Step 144). Of course, it should be understood that ACK/NACK response generation and transmission is an ongoing process that is typically done on a framed-by-frame basis with respect to the mobile station signal, and the sector selected for transmission of the ACK/NACK responses can be dynamically revised responsive to changing forward link conditions.

It therefore should be understood that the present invention is not limited by the above examples. Instead, the present invention is limited only by the following claims and their reasonable legal equivalents.

1. A method of generating ACK/NACKs responses at a cell site having multiple radio sectors, the method comprising:
receiving a mobile station signal at the cell site;
generating ACK/NACK responses for the mobile station signal that are common to all of the sectors receiving the mobile station signal; and
transmitting the ACK/NACK responses from the cell site to the mobile station.

2. The method of claim 1, wherein generating ACK/NACK responses for the mobile station signal that are common to all of the sectors receiving the mobile station signal comprises generating an ACK response if at least one of the sectors correctly receives the mobile station signal and otherwise generating a NACK response.

3. The method of claim 2, wherein generating an ACK response if at least one of the sectors correctly receives the mobile station signal and otherwise generating a NACK response is done on a frame-by-frame basis for the mobile station signal.

4. The method of claim 2, wherein generating an ACK response if at least one of the sectors correctly receives the mobile station signal and otherwise generating a NACK response comprises decoding a data frame for the mobile station signal as received at each of the sectors, generating an ACK response if any of the sectors correctly decoded the data frame, and otherwise generating a NACK response.

5. The method of claim 1, wherein generating ACK/NACK responses for the mobile station signal that are common to all of the sectors receiving the mobile station signal comprises forming a combined signal from the mobile station signal as received at each of the sectors, and generating ACK/NACK responses based on the combined signal.

6. The method of claim 5, wherein forming a combined signal from the mobile station signal as received at each of the sectors comprises performing Maximum Ratio Combining of the mobile station signal as received at each of the sectors.

7. The method of claim 5, wherein generating ACK/NACK responses based on the combined signal comprises decoding the combined signal, and generating an ACK response if the combined signal is correctly decoded, and otherwise generating a NACK response.

8. The method of claim 1, wherein transmitting the ACK/NACK responses from the cell site to the mobile station comprises transmitting the same ACK/NACK responses to the mobile station from each of the sectors.

9. The method of claim 1, wherein transmitting the ACK/NACK responses from the cell site to the mobile station comprises transmitting the ACK/NACK responses to the mobile station from one or more selected ones of the sectors.

10. The method of claim 9, further comprising selecting the sector operating as the current forward link serving sector for the mobile station as a selected one for transmitting the ACK/NACK responses to the mobile station.

11. The method of claim 9, further comprising evaluating one or more resource loading parameters for the sectors, and selecting a particular one of the sectors as a selected one for transmitting the ACK/NACK responses to the mobile station based on said evaluation.

12. The method of claim 1, wherein transmitting the ACK/NACK responses from the cell site to the mobile station comprises selecting one of the sectors that are receiving the mobile station signal based on comparing at least one of a forward link transmit power availability and a forward link loading for the sectors, and transmitting the ACK/NACK responses to the mobile station from that selected sector.

13. A cell-site radio base station having multiple radio sectors and comprising:
sectorized radio transceiver circuits configured to transmit and receive signals in each of two or more sectors of the radio base station; and
one or more processing circuits configured to generate ACK/NACK responses that are common to all of the sectors of the radio base station that receive a mobile station signal.

14. The radio base station of claim 13, wherein the one or more processing circuits are configured to generate ACK/NACK responses for the mobile station signal that are common to all of the sectors receiving the mobile station signal by generating an ACK response if at least one of the sectors correctly receives the mobile station signal and otherwise generating a NACK response.

15. The radio base station of claim 14, wherein the one or more processing circuits are configured to generate the ACK and NACK responses on a frame-by-frame basis for the mobile station signal.

16. The radio base station of claim 13, wherein the radio base station is configured to decode data frames for the mobile station signal as received at each of the sectors, and wherein the one or more processing circuits are configured to generate an ACK response if any of the data frames are correctly decoded, and otherwise generate a NACK response.

17. The radio base station of claim 13, wherein the radio base station is configured to form a combined signal from the mobile station signal as received at each of the sectors, and wherein the one or more processing circuits are configured to generate the ACK/NACK responses based on the combined signal.

18. The radio base station of claim 17, wherein the radio base station is configured to form the combined signal by performing Maximum Ratio Combining of the mobile station signal as received at each of the sectors.

19. The radio base station of claim 17, wherein the one or more processing circuits are configured to generate an ACK response if the combined signal is correctly decoded, and otherwise generating a NACK response.

20. The radio base station of claim 13, the radio base station is configured to transmit the ACK/NACK responses to the mobile station from each of the sectors, so that the same ACK/NACK responses are received by the mobile station from all of the sectors.

21. The radio base station of claim 13, wherein the radio base station is configured to transmit the ACK/NACK responses to the mobile station from one or more selected ones of the sectors.

22. The radio base station of claim 13, wherein the radio base station is configured to select the sector operating as the current forward link serving sector for the mobile station and to transmit the ACK/NACK responses from that selected sector.

23. The radio base station of claim 13, wherein the radio base station is configured to evaluate one or more resource loading parameters for the sectors, to select one of the sectors based on said evaluation, and to transmit the ACK/NACK responses from that selected sector.

24. A method of generating ACK/NACKs responses at a cell site having multiple radio sectors, the method comprising:
receiving a mobile station signal in softer handoff at two or more sectors of the cell site;
generating common ACK/NACK signals for all of the softer handoff sectors; and
transmitting the common ACK/NACK signals to the mobile station from the cell site.

25. A method of ACK/NACK processing at a mobile station comprising:
receiving a common ACK/NACK response transmitted from each of two or more sectors of a radio base station;
combining the common ACK/NACK responses from the two or more sectors to form combined ACK/NACK responses; and
controlling retransmissions for a reverse link signal being transmitted from the mobile station to the radio base station based on the combined ACK/NACK responses.
